(19) United States
(12) Patent Application Publication
(10) Pub. No.: US 2005/0150749 A1
(43) Pub. Date: Jul. 14, 2005

(54) Combined control electrical switch

(76) Inventor: Ssu-Min Lung, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/982,282

(22) Filed: Nov. 5, 2004

(30) Foreign Application Priority Data
Nov. 14, 2003 (TW) 92220204

(51) Int. Cl. H01H 9/00

(52) U.S. Cl. 200/4

(57) ABSTRACT

A combined control electrical switch (1) includes an insulative housing (2), an actuator (3), a movable contact (4), a torsion spring (5), and a cover (6). The housing has a base (20) and a C-shaped periphery wall (27) defining a pair of slits extending upwardly, thereby defining a cavity (201) therein. A plurality of fixed contacts (23, 24, 25) are mounted in the housing for detecting a rotating operation or depressing operation of the actuator. The actuator mounted on the housing is rotatable and depressable. The movable contact is attached to the actuator, so that the actuator is movable on the housing and then return to its original position. The torsion spring is mounted between the actuator and the housing and comprises a pair of arms (52) and bent ends (53).

### BACKGROUND OF THE INVENTION

1. Field of the Art

The present invention relates to an electrical switch, and particularly to an electrical switch which is rotatably and pressably actuated.

2. Discription of the Prior Art

Referring to FIG. 6, CN Pat. No. 97100709.8 discloses a known electrical switch. The electrical switch comprises a stationary housing 1′ having fixed contacts 11a′ and 12a′, an actuator 2′ mounted on the stationary housing 1′ which can be rotated and pressed, a slider 3′ mounted with the actuator 2′ and comprising contact portions 27a′ and 28′, and a torsion spring 4′ coupling with the actuator 2′ whose two arms 4b′ and 4c′ are fixed by fixing steps 8b′ of stationary housing 1′.

In operation, when the actuator 2′ is rotated or pressed, the slider 3′ can pivot on a post 9′ until the actuator 2′ abuts the stationary housing 1′. The contact portion 27a′ (or 28′) is actuated to contact with the fixed contact 11a′ (or 12a′). By this way, the contact portion 27a′ (or 28′) and the fixed contact 11a′ (or 12a′) are electrically connected. In operation, the two arms 4b′ and 4c′ of the torsion spring 4′are elastically deformed toward each other by the rotated or pressed actuator 2′ and the stationary housing 1′. Releasing the actuator 3, the restoration of the torsion spring 4′ brings the actuator 2′ to the normal status and breaks the electrical connection between the contact portion 27a′ (or 28a′) and fixed contact portion 11a′ (or 12a′).

However, the extend directions of the two arms 4b′ and 4c′ are not collinear with the direction of the press, the two arms 4b′ and 4c′ can not bear enough, which effects the performance of the switch.

### BREIF SUMMARY OF THE INVENTION

The purpose of the invention is to provide a switch, which has a better performance.

This invention is an electrical switch and the switch comprises an insulative housing, an actuator, a movable contact, a torsion spring, and a cover. The housing has a plan base and a C-shaped periphery wall extending upwardly and enclosing therearound, thereby defining a cavity therebetween. A plurality of fixed contacts are mounted in the housing for detecting a rotate operation or depressing operation of the actuator. The actuator mounted on the housing is rotatable and depressable. The movable contact attached to the actuator and the housing, whereby the actuator is elastically movable on the housing. The torsion spring is mounted between the actuator and the housing and comprises a pair of arms and bent ends. The C-shaped periphery wall of the housing further defines a pair of slits. The torsion spring is mounted between the actuator and the housing and comprises a pair of arms and bent ends, and the bent ends are caught in the slits.

Compare with the known switch, the merit of the invention is the torsion spring. The torsion spring of this invention further comprises bent end respectively to the two arms. The two bent ends are caught in slits defined in the housing, by this way, the problem of mentioned above can be solved.

### BREIF DESCRIPTION OF THE DRAWINGS

FIG. 1 is an exploded view of a combined control electrical switch in according with this invention;

FIG. 2 is an assembled view of FIG. 1;

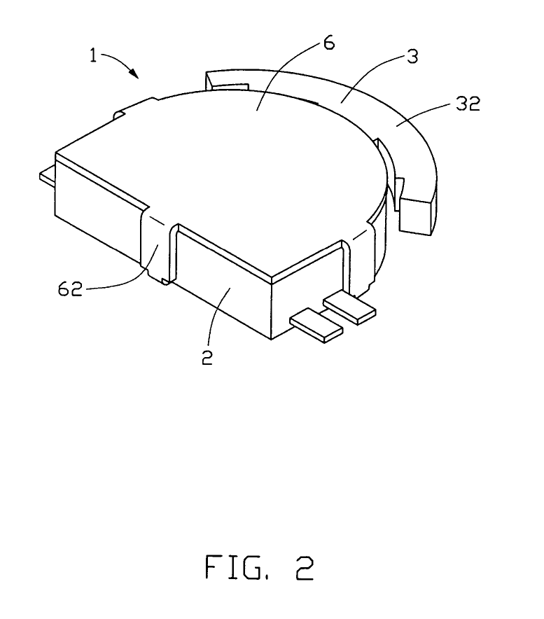

FIG. 3 is a partially assembled view of FIG. 1;

FIG. 4 is a top plan view of the switch of FIG. 2, wherein a cover of the switch are removed for clarity and an actuator is rotated;

FIG. 5 is a view similar to FIG. 4, but with the actuator pressed; and

FIG. 6 is an exploded view of a conventional switch.

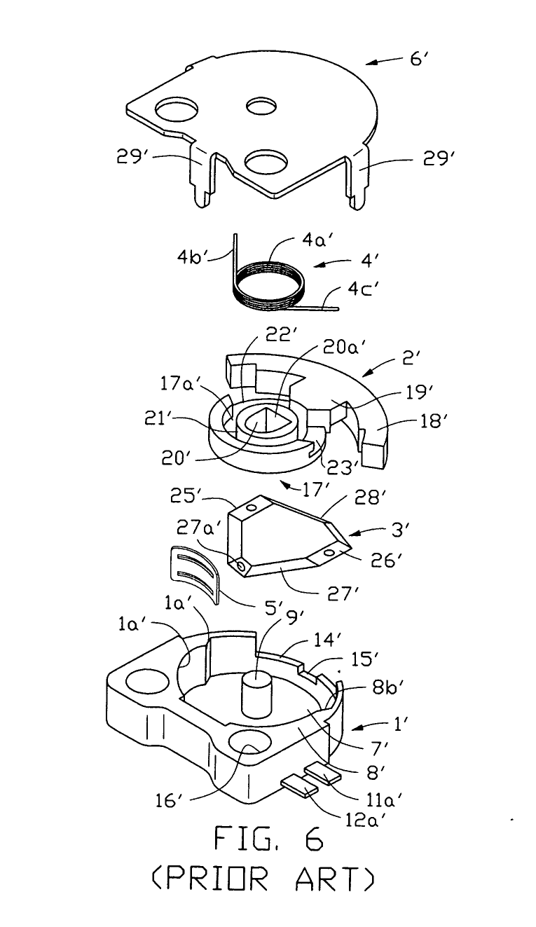

### DETAILED DESCRIPTION OF THE INVENTION

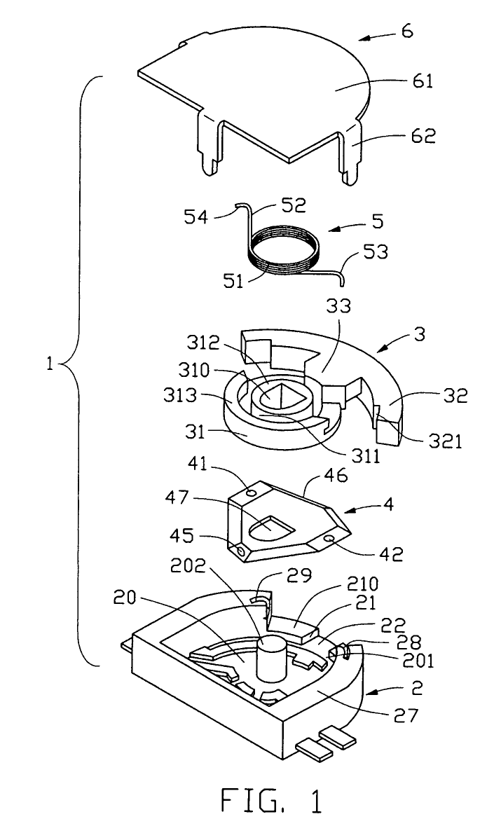

Referring to FIG. 1, a switch 1 comprises an insulative housing 2, an actuator 3, a movable contact 4, a torsion spring 5, and a cover 6.

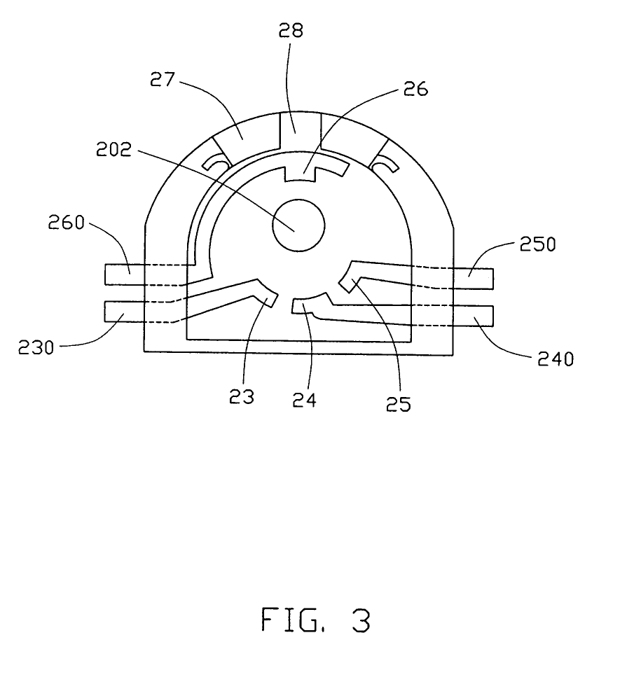

Referring to FIGS. 1 and 3, the housing 2 has a substantially semicircle plan base 20 and has a straight side and a circle side. A C-shaped periphery wall 27 extends upwardly from and substantially encloses around the base 20, thereby defining a cavity 201 therebetween. The C-shaped periphery wall 27 comprises opposite ends stopping at a circle side of the base 20. A pair of extending walls 21 extends towards each other from the opposite ends of the C-shaped periphery wall 27. A cutout 22 is defined between the extending walls 21. A pair of slits 28, 29 are respectively defined in the opposite ends of the C-shaped periphery wall 27. A post 202 upwardly projects at the central of the base 20. A first fixed contact 23, a second fixed contact 24, a third fixed contact 25 and a common contacting fixed contact 26 are embedded in the base 20 by insert molding. The common contacting fixed contact 26 is positioned corresponding to the second fixed contact 24. The fixed contacts 23, 24, 25 each have correspondingly a first terminal 230, 240, 250 extending out of the base 20. The common contacting fixed contact 26 has a second terminal 260 extending out of the base 20.

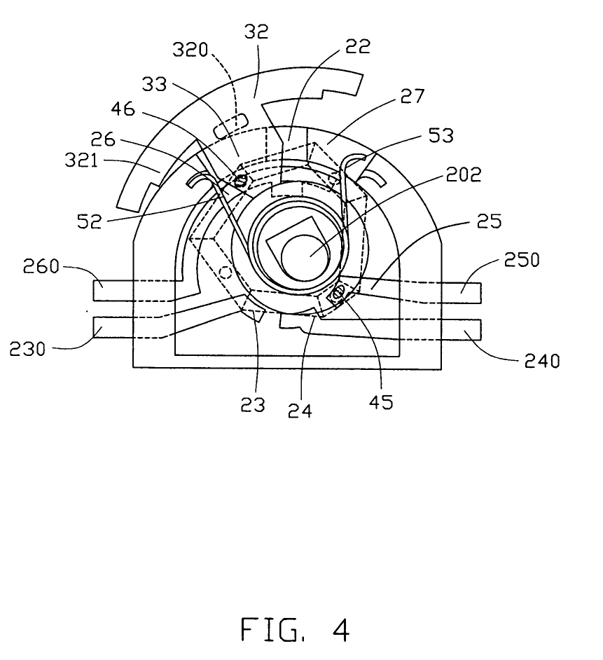

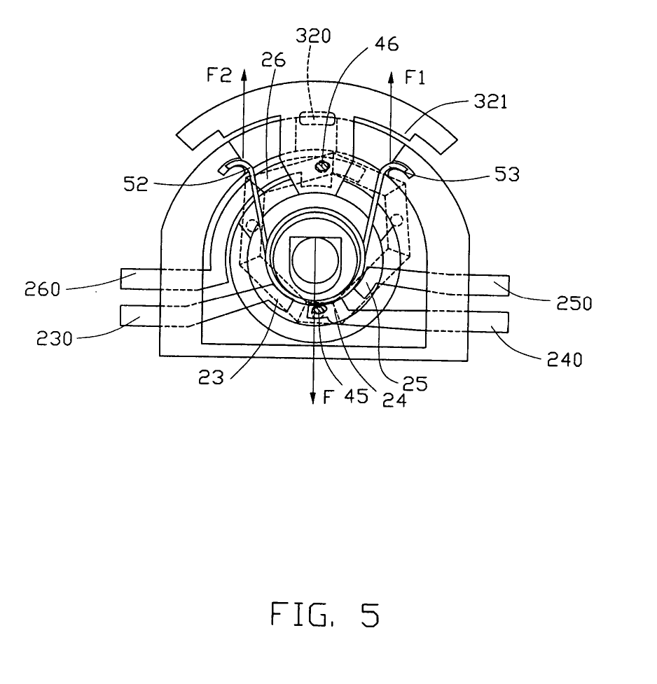

Referring to FIGS. 1 and 5, the actuator 3 comprises an operating portion 31 mounting in the cavity 201, a push portion 32 extending out of the base 20 and a connect portion 33 connecting the operating portion 31 and the push portion 32. The operating portion 31 is substantially planar and is substantially circle. A cylindrical protrusion 312 is upwardly formed at the central of the operating portion 31 and defines a through hole 310 therethrough. The through hole 310 is substantially semi-elliptical. A C-shaped wall 313 extends upwardly from the operating portion 31 and is opposite to the connect portion 33. A small notch (not labeled) is defined at a lower portion of one end of the C-shaped wall 313. An annular trough 311 is defined between the protrusion 312 and the C-shaped wall 313. The push portion 32 in an arch shaped configuration and has the same central axis as the operating portion 31. The push portion 32 has a projection 320 (shown in FIG. 4) projecting downwardly from the lower surface thereof. The push portion 32 further comprises a stopper wall 321 projecting from inner surface thereof and extending around the operating portion 31. The stopper wall 321 also has an arch-shaped configuration and a same central axis of the operating portion 31. The connect portion 33 connects the operating portion 31 and the push portion 32.

The movable contact 4 is mounted on the lower surface of the operating portion 31 and is movable with the actuator 3. A first contacting portion 45 and a second contacting portion 46 are respectively positioned on the movable contact 4 of which the second contacting portion 46 keeps in contacting with the common contacting fixed contact 26 and the first contacting portion 45 are movable to contact with the fixed contacts 23, 24, 25. A pair of fixing portions 41 and 42 are positioned on the movable contact 4 for fixing the movable contact 4 to the actuator 3. The movable contact 4 also has a coupling hole 47 corresponding to the through hole 310 defining therein.

The torsion spring 5 comprises a coiled portion 51 and a pair of arms 52. The two arms 52 corporately form a V-shaped configuration and each has an outwardly bent end 54. The cover 6 has a substantially plan plate which is configured corresponding to an outer profile of the housing 2. A plurality of tangs 62 extends downwardly from the lever edge of the plan plate 61 for securing on the base 2.

In assembly, The movable contact 4 mounts on the lower surface of the actuator 3 through the fixing portions 41 and 42 and the coupling hole 47 corresponding to the through hole 310. The actuator 3 mounts on the housing 2, wherein the through hole 310 and the coupling hole 47 couple with the post 202, the connect portion 33 is mounted on the extending wall 21 and the second contacting portion 46 contacts with the common contacting fixed contact 26. The torsion spring 5 is received in the annular trough 311 and one of the arms 52 is caught in the small notch of the C-shaped wall 313. The two arms 52 extend out of the operating portion 31 and the bent ends 54 are respectively caught in the slits 28, 29. The cover 6 engages with the housing 2 and each tang 62 has a foot tab at the lower ends and bent to abut against a lower surface of the housing 2, thereby being mounting on the housing 2.

Referring to FIGS. 1 and 4, in operation, when the actuator 3 is rotated, the movable contact 4 moves with the actuator 3. The first contact 45 contacts with the first fixed contact 23, and the first fixed contact 23 and the common contacting fixed contact 26 are electrically connected. The two arms 52 are elastically squeezed toward each other. The projection 320 abuts outer surface of the extending wall 21 and prevents downward movement of the actuator 3. Releasing the actuator 3, the recover force of the torsion spring 5 brings the actuator 3 to the normal status and breaks the electrical connection between the first fixed contact 23 and the common contacting fixed contact 26, thereby achieving the purpose of switching.

Respectively, when the actuator 3 is rotated in the other direction, the first contacting portion 45 contacts with the third fixed contact 25, and the third fixed contact 25 and common contacting fixed contact 26 are electrically connected. As is described above, the two arms 52 are elastically squeezed toward each other. The projection 320 abuts outer surface of the extending wall 21 and prevents downward movement of the actuator 3. Releasing the actuator 3, the recover force of the torsion spring 5 brings the actuator 3 to the normal status and breaks the electrical connection between the third fixed contact 25 and the common contacting fixed contact 26, thereby achieving the purpose of switching.

Referring to FIGS. 1 and 5, when the actuator 3 is pushed towards the housing 2, the movable contact 4 moves with the actuator 3 along the pushing direction. The first contacting portion 45 contacts with the second fixed contact 24 and the second fixed contact 24 and common contacting fixed contact 26 are electrically connected. The stopper wall 321 is pressed in open portion of the C-shaped periphery wall 27, which prevent the actuator 3 being rotated. The coiled portion 51 is received in the annular trough 311 of the actuator 3 and is pressed moving along the direction of the pressure. Releasing the actuator 3, the recover force of the torsion spring 5 brings the actuator 3 to the normal status and the electrical connection between the second fixed contact 24 and the common contacting fixed contact 26 breaks.

It will be understood that the invention may be embodied in other specific forms without departing from the spirit or central characteristics thereof. The present examples and embodiments, therefore, are to be considered in all respects as illustrative and not restrictive, and the invention is not be limited to the details given herein.

1. A combined control electrical switch comprising:
an insulative housing defining a pair of slits;
a common contacting fixed contact, a first fixed contact and a second fixed contact fixed in the housing;
an actuator rotatably and depressably mounted on the housing;
a movable contact attached to the actuator and movable therewith, the movable contact comprising a first contacting portion and a second contacting portion, the first contacting portion contacting with the first fixed contact to detect a rotating operation of the actuator and contacting with the second fixed contact to detect a depressing operation of the actuator, the second contacting portion contacting with the common contacting fixed contact; and
a torsion spring mounted between the actuator and the housing and comprising a pair of arms, each arm forming a bent end received in a corresponding slit of the housing.

2. The combined control electrical switch as claimed in claim 1, wherein the housing comprises a base for carrying the actuator, one of the base and the actuator forming a positioning portion and the other correspondingly defining an engaging portion to engage the positioning portion, whereby the actuator is retained on the housing.

3. The combined control electrical switch as claimed in claim 2, wherein the housing further comprises a C-shaped periphery wall formed on the base and a cavity defined therein for receiving the actuator.

4. The combined control electrical switch as claimed in claim 3, wherein the pair of slits are defined in the C-shaped periphery wall.

5. The combined control electrical switch as claimed in claim 1, wherein the actuator defines an annular trough, and wherein the torsion spring comprises a coiled portion coupling with the actuator and received in the annular trough.

6. An electrical switch comprising:
an insulative housing defining a cavity;
a plurality of fixed contacts disposed in the housing;
an actuator being moveably disposed in the cavity;
a movable contact attached to the actuator and movable therewith, the movable contact electrically connected to a first group of the fixed contacts during rotation of the actuator and to a second group of the fixed contacts, different from said first group, during depression of the actuator, and
a torsion spring mounted between the actuator and the housing and comprising a pair of arms so as to resist torque during said rotation of the actuator, each arm forming a bent end engaged with the housing to result in a combined reaction force in a direction essentially opposite to a depressing direction during said depression of the actuator.

7. The switch as claimed in claim 6, wherein the depression direction is perpendicular to a rotation axis of the rotation of the actuator.
